(19) United States
(12) Patent Application Publication
(10) Pub. No.: US 2026/0072241 A1
(43) Pub. Date: Mar. 12, 2026

(54) LENS APPARATUS AND IMAGING APPARATUS

(71) Applicant: CANON KABUSHIKI KAISHA, Tokyo (JP)

(72) Inventor: MAKOTO TAKAHASHI, Tochigi (JP)

(21) Appl. No.: 19/313,617

(22) Filed: Aug. 28, 2025

(30) Foreign Application Priority Data
Sep. 11, 2024 (JP) 2024-157162

(51) Int. Cl. G02B 7/16

(52) U.S. Cl. CPC G02B 7/16

(57) ABSTRACT

A lens apparatus includes a plurality of lenses, a first optical unit that includes a first part of the plurality of lenses, a second optical unit that includes a second part of the plurality of lenses, and a switching mechanism configured to switch between the first optical unit and the second optical unit, wherein a focal length of the first optical unit and a focal length of the second optical unit are equivalent to each other.

### BACKGROUND

### Field of the Technology

The aspect of the embodiments relates to a lens apparatus and an imaging apparatus for capturing still images and moving images.

### Description of the Related Art

In recent years, in the broadcast industry, video techniques for high resolution, such as 4K or 8K resolution, have been rapidly advancing. Consequently, various techniques have been developed for lens apparatuses used in broadcast cameras to support higher resolution.

On the other hand, there has been an increased demand for different visual expressions (visual effects) depending on a situation in which imaging is performed. For example, in live broadcasting, such as live sports broadcasting, in addition to the conventional visual expression that captures clear and sharp images, there is also a growing demand for a visual expression to capture images like a cinema. In this manner, lens apparatuses are in demand that can selectively capture images with different visual expressions, which normally capture sharp images with high resolution and can produce a bokeh blurring effect to highlight a subject at specific moments.

### SUMMARY

According to an aspect of the embodiments, a lens apparatus includes a plurality of lenses, a first optical unit that includes a first part of the plurality of lenses, a second optical unit that includes a second part of the plurality of lenses, and a switching mechanism configured to switch between the first optical unit and the second optical unit, and wherein a focal length of the first optical unit and a focal length of the second optical unit are equivalent to each other.

According to another aspect of the embodiments, a lens apparatus includes a plurality of lenses, a first optical unit that includes a first part of the plurality of lenses, a second optical unit that includes a second part of the plurality of lenses, and a switching mechanism configured to switch between the first optical unit and the second optical unit, and wherein a visual expression obtained by the lens apparatus with the first optical unit inserted in the lens apparatus and a visual expression obtained by the lens apparatus with the second optical unit inserted in the lens apparatus are different from each other.

According to yet another an aspect of the embodiments, a lens apparatus includes a plurality of lenses, a first optical unit that includes a first part of the plurality of lenses, a second optical unit that includes a second part of the plurality of lenses, and a switching mechanism configured to switch between the first optical unit and the second optical unit, wherein the following inequality is satisfied:

0.95<fu1/fu2<1.05,
where the focal length of the first optical unit is fu1 and the focal length of the second optical unit is fu2.

Features of the disclosure will become apparent from the following description of embodiments with reference to the attached drawings. The following description of embodiments is described by way of example.

### BRIEF DESCRIPTION OF THE DRAWINGS

FIGS. 1A and 1B are cross-sectional views of lenses according to a first exemplary embodiment.

FIG. 2 is a view illustrating a switching structure of an optical unit according to the first exemplary embodiment.

FIGS. 3A and 3B illustrate aberration diagrams according to the first exemplary embodiment.

FIG. 4 is a cross-sectional view of lenses according to a second exemplary embodiment.

FIG. 5 is a view illustrating a switching structure of an optical unit according to the second exemplary embodiment.

FIG. 6 illustrates an aberration diagram according to the second exemplary embodiment.

FIG. 7 is a cross-sectional view of lenses according to a third exemplary embodiment.

FIG. 8 illustrates an aberration diagram according to the third exemplary embodiment.

FIG. 9 is a schematic view of an imaging apparatus including a lens apparatus.

### DESCRIPTION OF THE EMBODIMENTS

Some exemplary embodiments in the specification will now be described in detail with reference to the drawings. The exemplary embodiments of the disclosure relate to a lens apparatus including a mechanism that switches between the optical units. The lens apparatus according to each exemplary embodiment is used in various kinds of imaging apparatuses, such as a broadcasting video camera, a movie camera, a general-purpose digital still camera, and a general-purpose digital video camera.

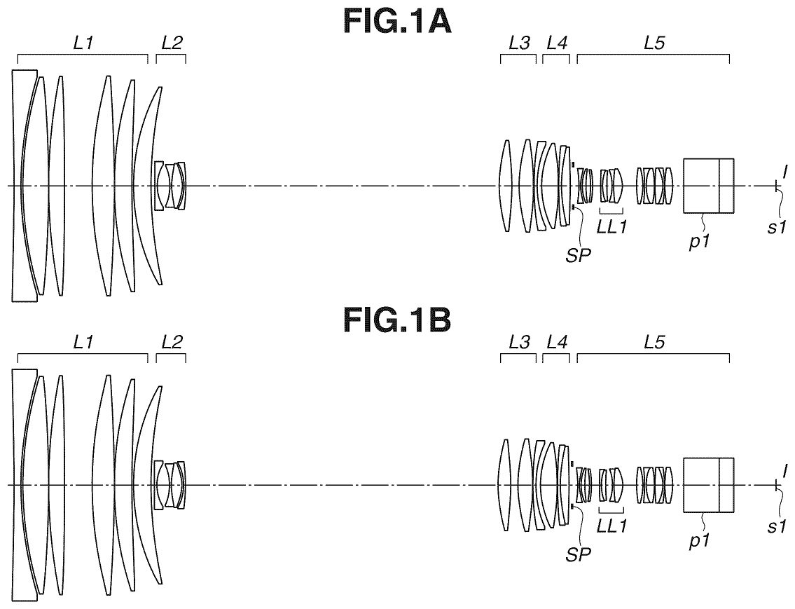

FIGS. 1A and 1B are cross-sectional views of lenses according to a first exemplary embodiment. FIG. 1A illustrates a cross-sectional view of lenses when a first optical unit 1 is inserted. As a visual expression (a visual effect), FIG. 1A illustrates a state in which a subject is captured in sharp focus. FIG. 1B illustrates a cross-sectional view of lenses when a second optical unit 2 is inserted. As a visual expression, FIG. 1B illustrates a state in which imaging is performed with a bokeh effect.

The lens apparatus according to the exemplary embodiment includes a first lens group L1 having positive refractive power, a second lens group L2 having negative refractive power, a third lens group L3 having positive refractive power, a fourth lens group L4 having positive refractive power, and a fifth lens group L5 having positive refractive power. The lens apparatus according to the exemplary embodiment is a zoom lens in which while the first lens group L1 and the fifth lens group L5 are fixed during magnification change, the second lens group L2, the third lens group L3, and the fourth lens group L4 move along different trajectories. Further, the lens apparatus has a configuration including an aperture stop SP on the enlargement-conjugate side of the fifth lens group L5. In this manner, with a multi-group configuration including a plurality of lens groups, the lens apparatus according to the exemplary embodiment is configured to serve as a high-magnification zoom lens and perform imaging at high resolution.

Further, an optical unit LL1, which is a part of the fifth lens group L5, is configured to be switchable. Switching within a stationary lens group that does not move during magnification change makes it possible to stably switch between video images with reduced error in the mechanical structure.

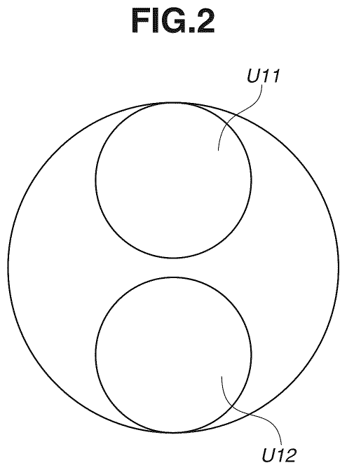

In the exemplary embodiment, use of a rotary switching mechanism as illustrated in FIG. 2 makes it possible to switch between the optical units of different types (the first optical unit 1 and the second optical unit 2) while downsizing the lens apparatus. However, if the first optical unit 1 and the second optical unit 2 are different in focal length, a field of view (an angle of view) changes at the time of switching, which gives a sense of incongruity to a viewer. Thus, in the lens apparatus according to the exemplary embodiment, making the focal length of the first optical unit 1 and that of the second optical unit 2 equivalent to each other prevents a change in field of view at the time of switching between the optical units.

Specifically, when the focal length of the first optical unit 1 is fu1 and the focal length of the second optical unit 2 is fu2, the following condition is satisfied.

$$0.95 < fu 1 / fu 2 < 1.05 \qquad ( 1 )$$

The condition in the inequality (1) indicates that the focal length of the first optical unit 1 and the focal length of the second optical unit 2 are equivalent to each other.

In one embodiment, the range in the inequality (1) is set as follows:

$$0.99 < fu 1 / fu 2 < 1.01 \qquad ( 1 a )$$

An optical element that enables a sharp visual expression is disposed in the first optical unit 1, while an optical element that enables a visual expression with a bokch effect is disposed in the second optical unit 2.

This configuration makes it possible to instantaneously perform imaging with different visual expressions by selectively switching between the first optical unit 1 and the second optical unit 2, for example, during live sports broadcasting, without change in the field of view (the angle of view), enabling visually consistent imaging.

A configuration for switching between the optical units to implement different visual expressions will now be described. Specifically, an optical system of each optical unit is configured so that a spherical aberration in the lens apparatus is different between when the first optical unit 1 is inserted and when the second optical unit 2 is inserted.

In the exemplary embodiment, the lens apparatus is configured to reduce a spherical aberration when the first optical unit 1 that implements a sharp visual expression is inserted, and intentionally produce a spherical aberration when the second optical unit 2 that implements a visual expression to add bokeh is inserted.

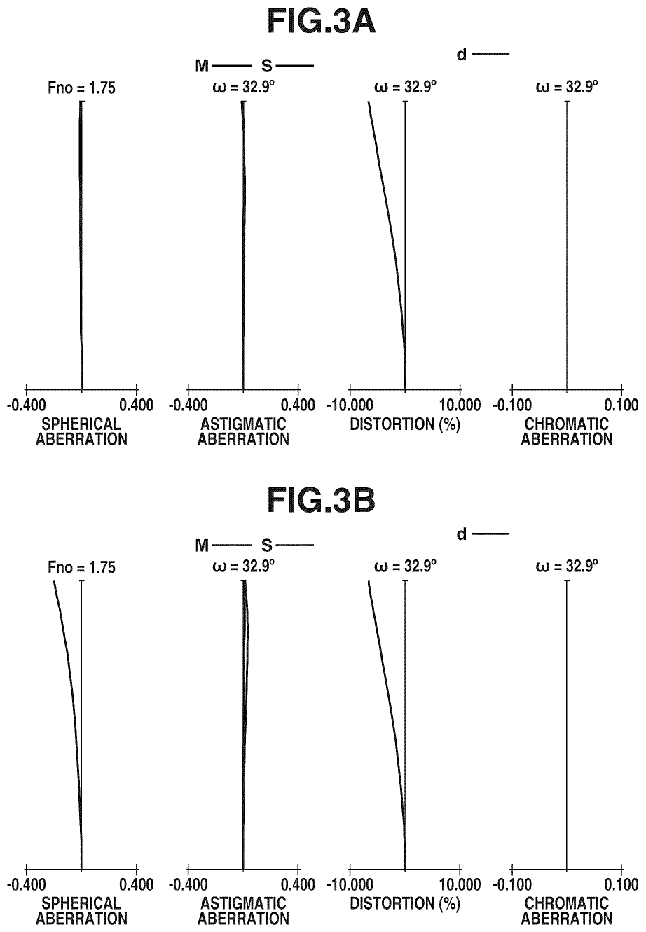

FIGS. 3A and 3B illustrate aberration diagrams according to the exemplary embodiment. FIG. 3A illustrates an aberration diagram when the above-described first optical unit 1 is inserted. FIG. 3B illustrates an aberration diagram when the above-described second optical unit 2 is inserted. As can be understood by comparing the spherical aberrations illustrated in FIGS. 3A and 3B, the spherical aberration when the first optical unit 1 is inserted is smaller than that when the second optical unit 2 is inserted. Thus, video images captured by the optical system having characteristics illustrated in FIG. 3A are sharp video images at high resolution. In contrast, video images captured by the optical system having characteristics illustrated in FIG. 3B can be video images to which bokeh is added to highlight subjects.

Setting the spherical aberration to an under-corrected state (i.e., on the subject side with respect to the sensor surface) and satisfying the following condition makes it possible to capture video images with a more desired bokeh effect.

Specifically, when a pixel width of a sensor (an image sensor) is p and an amount of a spherical aberration is SA, the following inequality is satisfied.

$$- 170 < SA / p < 0 \qquad ( 2 )$$

Satisfying the inequality (2) makes it possible to achieve a more desirable bokeh effect.

In one embodiment, the range in the inequality (2) is set as follows.

$$- 85 < SA / p < 0 \qquad ( 2 a )$$

When the second optical unit 2 according to the exemplary embodiment is inserted, SA is −0.20 millimeters (mm), the pixel width of the sensor (a sensor pitch) P is 0.0025 mm, and Sa/p=−80, which satisfy the inequalities (2) and (2a), and thus, achieve a more desirable bokeh effect.

As a specific configuration, changing one of the radius of curvature, lens spacing, and refractive index of a desirably-selected lens from among lenses included in the first optical unit 1 and the second optical unit 2 makes it possible to implement the above-described difference in spherical aberration.

Flange back (FB) adjustment will now be described. In the exemplary embodiment, when switching is performed between the first optical unit 1 and the second optical unit 2, the spherical aberration changes and a focal position suitable for a visual expression also changes.

For example, in the exemplary embodiment, the spherical aberration (SA) is undercorrected when the second optical unit 2 is inserted. Thus, setting the value of the FB also relatively in the undercorrected direction (for example, −0.03 mm) makes it possible to produce a more desirable visual expression.

This value of the FB position (an adjustment value) may be switched depending on a user's wish or the like. Thus, in the exemplary embodiment, an FB adjustment mechanism provided in the configuration makes it possible to adjust the FB position to an appropriate focal position depending on the type of the optical unit to be inserted or the user's wish. Further, adjusting the FB position depending on the zoom state, the focus state, or the aperture stop state of the lens apparatus makes it possible to produce a desirable visual expression in any imaging situation.

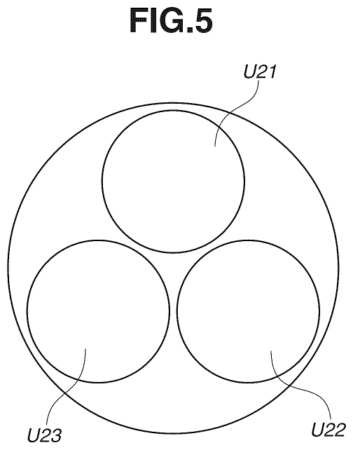

Switching between the optical units in the lens apparatus described in the specification is not limited to between the two types illustrated in FIG. 2 (i.e., the first optical unit 1 in U11 and the second optical unit 2 in U12). For example, the lens apparatus may be configured to perform switching to, other than the first optical unit 1 and the second optical unit 2, a third optical unit 3 that increases an imaging magnification as illustrated in FIG. 5. Further, the lens apparatus may have a mode of switching between four or more optical units.

In the lens apparatus in the specification, in one embodiment, light beams passing an optical unit is to be afocal to prevent focus shift due to positional error when the optical unit is inserted (at the time of switching).

The optical unit LL1 included in the fifth lens group L5, which is a stationary lens group, is a switchable optical unit, and includes four lenses: a lens having negative refractive power, a lens having positive refractive power, a lens having negative refractive power, and a lens having positive refractive power. A glass block p1 is a color separation prism, an optical filter, or the like. The imaging surface (the light receiving surface) of an image sensor s1 as a photoelectric conversion element is disposed on an image plane I.

In the exemplary embodiment, with the configuration that satisfies the above-described inequalities (1) and (2), the lens apparatus is implemented that can perform imaging with different visual expressions at equivalent imaging magnifications.

The values in the inequalities (1) and (2) in a first numerical example are shown in Table (B).

FIG. 2 is an image diagram illustrating a switching structure of the optical unit according to the exemplary embodiment. In this configuration, the first optical unit 1 and the second optical unit 2 are respectively disposed in U11 and U12 in the switching structure illustrated in FIG. 2.

FIGS. 3A and 3B illustrate aberration diagrams (d line representations) regarding the lens apparatus according to the exemplary embodiment. FIG. 3A illustrates aberration diagrams at the wide-angle end when the first optical unit 1 is inserted into the optical unit LL1. FIG. 3B illustrates aberration diagrams at the wide-angle end when the second optical unit 2 is inserted into the optical unit LL1. It can be understood that the spherical aberration illustrated in FIG. 3B is significantly undercorrected in comparison with the spherical aberration illustrated in FIG. 3A.

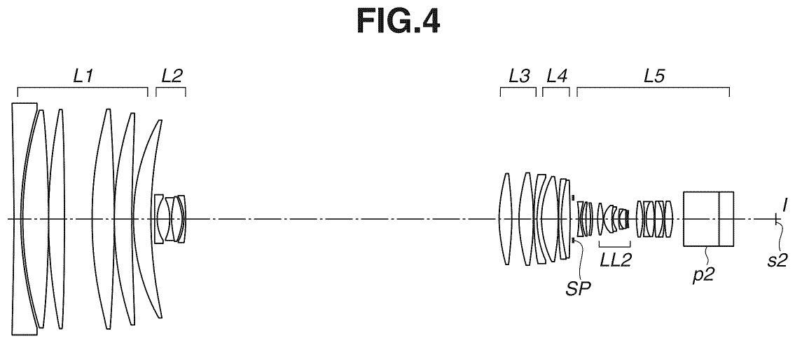

A second exemplary embodiment will now be described. FIG. 4 is a cross-sectional view of an imaging lens unit in a lens apparatus according to the exemplary embodiment. FIG. 4 is a cross-sectional view when the third optical unit 3 is inserted.

FIG. 4 illustrates the exemplary embodiment in a case where the third optical unit 3 is switchable, in addition to the first optical unit 1 and the second optical unit 2 according to the first exemplary embodiment. The lens apparatus according to the exemplary embodiment enables switching between the three different optical units. The configurations of the first optical unit 1 and the second optical unit 2 according to the exemplary embodiment are similar to those in the first exemplary embodiment, and thus, the description thereof will be omitted.

The imaging lens unit according to the exemplary embodiment is a zoom lens. The imaging lens unit according to the exemplary embodiment includes the first lens group L1 having positive refractive power that does not move for magnificent change and the second lens group L2 having negative refractive power that moves for magnificent change. The first lens group L1 and the second lens group L2 are sequentially arranged from the enlargement conjugate (the object side) toward the image. The imaging lens unit further includes the third lens group L3 having positive refractive power that moves for magnificent change, the fourth lens group LA having positive refractive power that moves for magnificent change, and the fifth lens group L5 having positive refractive power that does not move for magnificent change. The aperture stop SP is positioned on the magnification conjugate side of the fifth lens group L5, and is fixed during magnificent change.

An optical unit LL2 included in the fifth lens group L5, which is a stationary lens group, is a switchable optical unit, and includes four lenses: a lens having negative refractive power, a lens having positive refractive power, a lens having negative refractive power, and a lens having positive refractive power. A glass block p2 is a color separation prism, an optical filter, or the like. The imaging surface (the light receiving surface) of an image sensor s2 as a photoelectric conversion element is disposed on the image plane I.

FIG. 5 is an image diagram illustrating a switching structure of the optical unit according to the exemplary embodiment. In this configuration, the first optical unit 1, the second optical unit 2, and the third optical unit 3 that is capable of doubling an imaging magnification are respectively disposed in U21, U22, and U23 in the switching structure illustrated in FIG. 5.

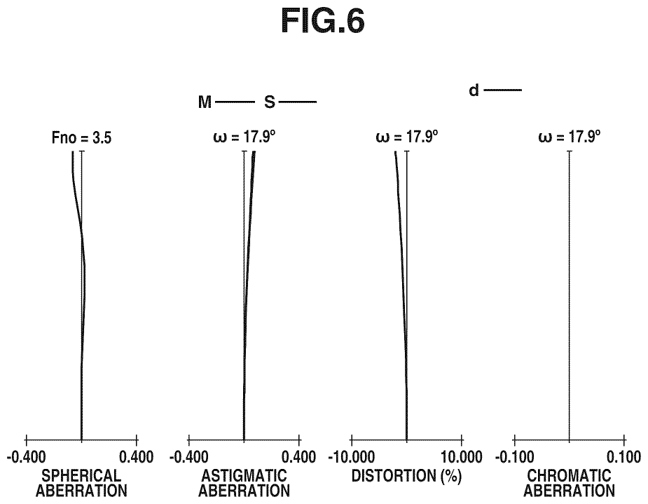

FIG. 6 illustrates an aberration diagram (a d line representation) regarding the lens apparatus according to the exemplary embodiment. FIG. 6 illustrates the aberration diagram at the wide-angle end when the third optical unit 3 is inserted into the optical unit LL2. Similar to the spherical aberration illustrated in FIG. 3A, the spherical aberration illustrated in FIG. 6 is reduced to a low level. Thus, the third optical unit 3 is configured to perform imaging at an imaging magnification different from that of the second optical unit 2 and produce a visual expression different from that produced by the second optical unit 2. Further, the third optical unit 3 is configured to perform imaging at an imaging magnification different from that of the first optical unit 1 and produce a visual expression equivalent to that produced by the first optical unit 1.

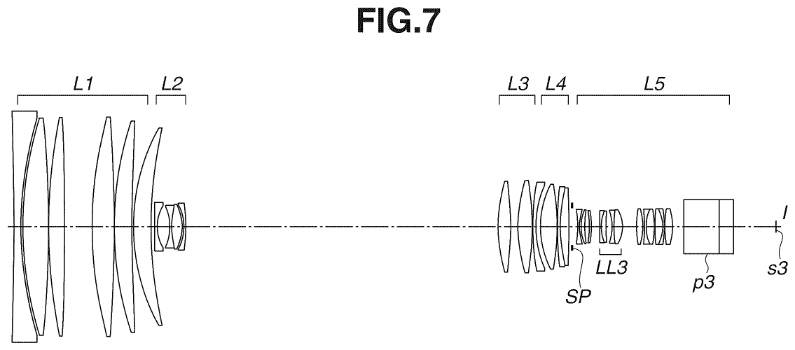

A third exemplary embodiment will now be described. FIG. 7 is a cross-sectional view of an imaging lens unit in a lens apparatus according to the third exemplary embodiment. FIG. 7 is a cross-sectional view when a fourth optical unit 4 is inserted.

FIG. 7 illustrates the exemplary embodiment in a case where the fourth optical unit 4 is switchable, which is different from the second optical unit 2 in spherical aberration described in the first exemplary embodiment. The lens apparatus according to the exemplary embodiment may be capable of switching between two different optical units similar to the first exemplary embodiment, or may be capable of switching between three different optical units similar to the second exemplary embodiment. The configuration of the first optical unit 1 according to the exemplary embodiment is similar to that according to the first exemplary embodiment, and thus, the description thereof will be omitted.

The imaging lens unit according to the exemplary embodiment is a zoom lens. The imaging lens unit according to the exemplary embodiment includes the first lens group L1 having positive refractive power that does not move for magnificent change, and the second lens group L2 having negative refractive power that moves for magnificent change. The first lens group L1 and the second lens group L2 are sequentially arranged from the enlargement conjugate (the object side) toward the image. The imaging lens unit further includes the third lens group L3 having positive refractive power that moves for magnificent change, the fourth lens group LA having positive refractive power that moves for magnificent change, and the fifth lens group L5 having positive refractive power that does not move for magnificent change. The aperture stop SP is positioned on the enlargement conjugate side of the fifth lens group L5, and is fixed during magnificent change.

An optical unit LL3 included in the fifth lens group L5, which is a stationary lens group, is a switchable optical unit, and includes four lenses: a lens having negative refractive power, a lens having positive refractive power, a lens having negative refractive power, and a lens having positive refractive power. A glass block p3 is a color separation prism, an optical filter, or the like. The imaging surface (the light receiving surface) of an image sensor s3 as a photoelectric conversion element is disposed on the image plane I.

In the exemplary embodiment, with the configuration that satisfies the above-described inequalities (1) and (2), the lens apparatus is implemented that is compact and capable of performing imaging with different visual expressions at equivalent imaging magnifications.

The values in the inequalities (1) and (2) in a third numerical example are shown in Table (B).

A switching structure of the optical unit according to the exemplary embodiment may be a structure illustrated in FIG. 2, or a structure illustrated in FIG. 5. For example, in the case of the switching mechanism illustrated in FIG. 2, the first optical unit 1 can be disposed in U11, and the fourth optical unit 4 can be disposed in U12. In the case of the switching mechanism illustrated in FIG. 5, the first optical unit 1 can be disposed in U21, the fourth optical unit 4 can be disposed in U22, and the third optical unit 3 that is capable of doubling an imaging magnification can be disposed in U23. Further, in the case of the switching mechanism illustrated in FIG. 5, the first optical unit 1 can be disposed in U21, the second optical unit 2 can be disposed in U22, and the fourth optical unit 4 can be disposed in U23. In this manner, three or more optical units that are different in visual expression may be disposed.

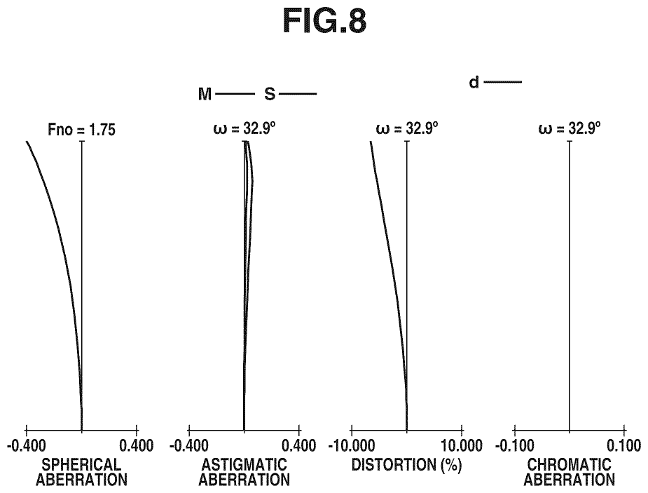

FIG. 8 illustrates an aberration diagram (a d line representation) regarding the lens apparatus according to the exemplary embodiment. FIG. 8 illustrates the aberration diagram at the wide-angle end when the fourth optical unit 4 is inserted into the optical unit LL3. It can be understood that the spherical aberration illustrated in FIG. 8 is significantly undercorrected in comparison with the spherical aberration illustrated in FIG. 3B when the second optical unit 2 is inserted.

The first to third numerical examples respectively corresponding to the first to third exemplary embodiments will now be described. In each numerical example, a surface number i represents the order of a surface from the object. r represents the radius (mm) of curvature of the i-th surface from the object, and d represents the lens thickness or the air spacing (mm) on the optical axis between the i-th surface and the (i+1)-th surface. nd represents the refractive index of the optical material at the d line under one atmosphere between the i-th surface and the (i+1)-th surface. vd represents the Abbe number of the optical material based on the d line between the i-th surface and the (i+1)-th surface. When refractive indices at wavelengths of Fraunhofer d, F, and C lines (587.6 nm, 486.1 nm, and 656.3 nm, respectively) are Nd, NF, an NC, respectively, the Abbe number vd with the d line serving as the reference is expressed as follows:

$$v d = ( N d - 1 ) / ( NF - NC )$$

When a diagonal size of the image sensor in the imaging apparatus using lenses is 2Y and a focal length of a zoom lens at the wide-angle end is fw, a half angle of view ω (°) is expressed as follows:

ω=arctan(Y/fw)

The maximum image height (mm) corresponds to Y, which is half (for example, 5.50 mm) of the diagonal size 2Y (for example, 11.00 mm).

BF represents the back focus (mm). The back focus represents, as an air-converted length, a distance on the optical axis from a lens surface of the zoom lens disposed closest to an image (the final surface) to a paraxial image plane. A total lens length (mm) is obtained by adding the back focus to a distance on the optical axis from a lens surface of the zoom lens disposed closest to an object (the forefront surface) to the final surface.

An asterisk (*) added to a surface number indicates that the surface has an aspheric surface shape. Assuming that X represents a displacement amount from a surface vertex in the optical axis direction, H represents a height from the optical axis in a direction perpendicular to the optical axis, the light travelling direction is a positive direction, R represents a paraxial radius of curvature, K represents a conic constant, and A4 to A16 represent respective aspheric surface coefficients, the aspheric shape can be expressed by the following expression.

$$X = \frac{{H}^{2} / R}{1 + \sqrt{1 - ( 1 + K ) {( H / R )}^{2}}} + A 4 {H}^{4} + A 6 {H}^{6} + A 8 {H}^{8} + A 10 {H}^{10} + A 12 {H}^{12} + A 14 {H}^{14} + A 16 {H}^{16} + A 3 {H}^{3} + A 5 {H}^{5} + A 7 {H}^{7} + A 9 {H}^{9} + A 11 {H}^{11} + A 13 {H}^{13} + A 15 {H}^{15}$$

“e±Z” in the conic constant and the aspheric surface coefficient means “×10^{±Z}” The above description about numeric examples applies to any of numeric examples to be described in the following.

### First Numerical Example

### (A) Lens Configuration

### 1-1: When the First Optical Unit 1 is Inserted (a Sharp Focus State)

Unit: mm
Surface data

| Surface number | r | d | nd | νd |
|---|---|---|---|---|
| 1 | −2942.188 | 6.00 | 1.83481 | 42.7 |
| 2 | 335.459 | 1.80 | | |
| 3 | 335.066 | 23.71 | 1.43387 | 95.1 |
| 4 | −1057.929 | 0.20 | | |
| 5 | 525.299 | 14.68 | 1.43387 | 95.1 |
| 6 | −2449.905 | 25.25 | | |
| 7 | 377.042 | 20.53 | 1.43387 | 95.1 |
| 8 | −1365.497 | 0.25 | | |
| 9 | 306.954 | 16.16 | 1.43387 | 95.1 |
| 10 | 1716.232 | 1.50 | | |
| 11 | 188.244 | 16.19 | 1.43875 | 94.7 |
| 12 | 408.078 | (variable) | | |
| 13* | −532.824 | 2.20 | 2.00330 | 28.3 |
| 14 | 38.132 | 11.72 | | |
| 15 | −44.546 | 1.45 | 1.74320 | 49.3 |
| 16 | 72.565 | 9.77 | 1.89286 | 20.4 |
| 17 | −46.484 | 1.63 | | |
| 18 | −41.758 | 2.00 | 1.88300 | 40.8 |
| 19 | −152.608 | (variable) | | |
| 20 | 152.336 | 11.49 | 1.72916 | 54.7 |
| 21* | −265.715 | 6.62 | | |
| 22 | 139.888 | 13.50 | 1.43875 | 94.7 |
| 23 | −246.304 | 0.50 | | |
| 24 | 264.094 | 2.60 | 1.85478 | 24.8 |
| 25 | 97.106 | (variable) | | |
| 26 | 86.506 | 15.39 | 1.49700 | 81.5 |
| 27 | −236.969 | 0.50 | | |
| 28 | 415.877 | 2.50 | 1.80518 | 25.4 |
| 29 | 139.362 | 7.85 | 1.60311 | 60.6 |
| 30* | −764.201 | (variable) | | |
| 31(stop) | ∞ | 5.46 | | |
| 32 | −100.588 | 1.40 | 1.88300 | 40.8 |
| 33 | 50.285 | 1.36 | | |
| 34 | 40.817 | 3.60 | 1.92286 | 18.9 |
| 35 | 96.042 | 4.19 | | |
| 36 | −79.866 | 1.70 | 1.80400 | 46.5 |
| 37 | −114.439 | 7.69 | | |
| 38 | 447.233 | 1.50 | 1.80400 | 46.5 |
| 39 | 36.261 | 4.29 | 1.84666 | 23.9 |
| 40 | 154.673 | 4.71 | | |
| 41 | −40.896 | 1.50 | 1.89190 | 37.1 |
| 42 | 100.531 | 8.12 | 1.51633 | 64.1 |
| 43 | −29.819 | 12.96 | | |
| 44 | 95.109 | 5.83 | 1.51742 | 52.4 |
| 45 | −65.823 | 1.40 | | |
| 46 | −142.700 | 1.50 | 1.88300 | 40.8 |
| 47 | 37.951 | 7.64 | 1.48749 | 70.2 |
| 48 | −86.098 | 0.20 | | |
| 49 | 111.798 | 7.63 | 1.51742 | 52.4 |
| 50 | −35.378 | 1.50 | 1.88300 | 40.8 |
| 51 | −107.947 | 0.20 | | |
| 52 | 90.094 | 7.67 | 1.53996 | 59.5 |
| 53 | −53.741 | 10.00 | | |
| 54 | ∞ | 33.00 | 1.60859 | 46.4 |
| 55 | ∞ | 13.20 | 1.51633 | 64.2 |
| 56 | ∞ | 13.30 | | |
| Image plane | ∞ | | | |

Aspheric surface data
Thirteenth surface

| | | | | | | | |
|---|---|---|---|---|---|---|---|
| K = | A4 = | A6 = | A8 = | A10 = | A12 = | A14 = | A16 = |
| 1.99852e+00 | 1.15677e−06 | −2.75064e−08 | −3.06848e−10 | 9.10515e−13 | 3.28486e−15 | 1.35261e−18 | 5.54400e−22 |
| A3 = | A5 = | A7 = | A9 = | A11 = | A13 = | A15 = | |
| 2.74335e−07 | 9.95673e−08 | 4.02226e−09 | 6.12079e−12 | −8.52506e−14 | −6.85632e−17 | −3.84859e−20 | |

Twenty-first surface

| | | | | | | | |
|---|---|---|---|---|---|---|---|
| K = | A4 = | A6 = | A8 = | A10 = | A12 = | A14 = | A16 = |
| 1.21093e+01 | 2.82183e−07 | −5.59441e−11 | −2.00796e−14 | 9.78964e−17 | −6.30815e−20 | 1.70834e−23 | −4.73901e−27 |
| A3 = | A5 = | A7 = | A9 = | A11 = | A13 = | A15 = | |
| −2.90901e−08 | 1.58196e−09 | 1.10620e−12 | −1.50730e−15 | 5.86871e−20 | 1.04584e−22 | 1.44467e−25 | |

Thirtieth surface

| | | | | | | | |
|---|---|---|---|---|---|---|---|
| K = | A4 = | A6 = | A8 = | A10 = | A12 = | A14 = | A16 = |
| −2.23400e+02 | 2.77687e−07 | 4.69555e−10 | 1.39733e−13 | −2.98156e−16 | 4.58582e−19 | −2.25443e−22 | 5.80568e−26 |
| A3 = | A5 = | A7 = | A9 = | A11 = | A13 = | A15 = | |
| 1.70768e−07 | −5.73181e−09 | −1.36230e−11 | 7.92918e−15 | −8.14405e−18 | 2.06016e−21 | −8.57551e−25 | |

Various Data

| Zoom ratio | | | 119.84 | | |
|---|---|---|---|---|---|
| Focal length | 8.51 | 28.15 | 100.04 | 339.91 | 1019.53 |
| F-number | 1.75 | 1.75 | 1.75 | 1.75 | 5.25 |
| Angle of view | 32.88 | 11.05 | 3.15 | 0.93 | 0.31 |
| Image height | 5.50 | 5.50 | 5.50 | 5.50 | 5.50 |
| Total lens length | 677.55 | 677.55 | 677.55 | 677.55 | 677.55 |
| BF | 13.30 | 13.30 | 13.30 | 13.30 | 13.30 |
| d12 | 3.47 | 94.70 | 154.53 | 185.25 | 194.08 |
| d19 | 289.33 | 168.20 | 96.92 | 55.51 | 2.00 |
| d25 | 4.21 | 21.63 | 10.30 | 4.07 | 4.44 |
| d30 | 2.99 | 15.47 | 38.25 | 55.16 | 99.48 |

Zoom lens group data

| Group | Starting surface | Focal length |
|---|---|---|
| 1 | 1 | 251.76 |
| 2 | 13 | −24.09 |
| 3 | 20 | 134.68 |
| 4 | 26 | 112.47 |
| 5 | 31 | 42.14 |

### 1-2: When the Second Optical Unit 2 is Inserted (a Bokch State)

Unit: mm
Surface data

| Surface number | r | d | nd | νd |
|---|---|---|---|---|
| 1 | −2942.188 | 6.00 | 1.83481 | 42.7 |
| 2 | 335.459 | 1.80 | | |
| 3 | 335.066 | 23.71 | 1.43387 | 95.1 |
| 4 | −1057.929 | 0.20 | | |
| 5 | 525.299 | 14.68 | 1.43387 | 95.1 |
| 6 | −2449.905 | 25.25 | | |
| 7 | 377.042 | 20.53 | 1.43387 | 95.1 |
| 8 | −1365.497 | 0.25 | | |
| 9 | 306.954 | 16.16 | 1.43387 | 95.1 |
| 10 | 1716.232 | 1.50 | | |
| 11 | 188.244 | 16.19 | 1.43875 | 94.7 |
| 12 | 408.078 | (variable) | | |
| 13* | −532.824 | 2.20 | 2.00330 | 28.3 |
| 14 | 38.132 | 11.72 | | |
| 15 | −44.546 | 1.45 | 1.74320 | 49.3 |
| 16 | 72.565 | 9.77 | 1.89286 | 20.4 |
| 17 | −46.484 | 1.63 | | |
| 18 | −41.758 | 2.00 | 1.88300 | 40.8 |
| 19 | −152.608 | (variable) | | |
| 20 | 152.336 | 11.49 | 1.72916 | 54.7 |
| 21* | −265.715 | 6.62 | | |
| 22 | 139.888 | 13.50 | 1.43875 | 94.7 |
| 23 | −246.304 | 0.50 | | |
| 24 | 264.094 | 2.60 | 1.85478 | 24.8 |
| 25 | 97.106 | (variable) | | |
| 26 | 86.506 | 15.39 | 1.49700 | 81.5 |
| 27 | −236.969 | 0.50 | | |
| 28 | 415.877 | 2.50 | 1.80518 | 25.4 |
| 29 | 139.362 | 7.85 | 1.60311 | 60.6 |
| 30* | −764.201 | (variable) | | |
| 31(stop) | ∞ | 5.46 | | |
| 32 | −100.588 | 1.40 | 1.88300 | 40.8 |
| 33 | 50.285 | 1.36 | | |
| 34 | 40.817 | 3.60 | 1.92286 | 18.9 |
| 35 | 96.042 | 4.19 | | |
| 36 | −79.866 | 1.70 | 1.80400 | 46.5 |
| 37 | −114.439 | 7.69 | | |
| 38 | 592.419 | 1.50 | 1.80400 | 46.5 |
| 39 | 36.658 | 4.29 | 1.84666 | 23.9 |
| 40 | 154.907 | 5.88 | | |
| 41 | −42.139 | 1.50 | 1.89190 | 37.1 |
| 42 | 100.900 | 8.12 | 1.51633 | 64.1 |
| 43 | −30.067 | 12.96 | | |
| 44 | 95.109 | 5.83 | 1.51742 | 52.4 |
| 45 | −65.823 | 1.40 | | |
| 46 | −142.700 | 1.50 | 1.88300 | 40.8 |
| 47 | 37.951 | 7.64 | 1.48749 | 70.2 |
| 48 | −86.098 | 0.20 | | |
| 49 | 111.798 | 7.63 | 1.51742 | 52.4 |
| 50 | −35.378 | 1.50 | 1.88300 | 40.8 |
| 51 | −107.947 | 0.20 | | |
| 52 | 90.094 | 7.67 | 1.53996 | 59.5 |
| 53 | −53.741 | 10.00 | | |
| 54 | ∞ | 33.00 | 1.60859 | 46.4 |
| 55 | ∞ | 13.20 | 1.51633 | 64.2 |
| 56 | ∞ | 13.30 | | |
| Image plane | ∞ | | | |

Aspheric surface data
Thirteenth surface

| | | | | | | | |
|---|---|---|---|---|---|---|---|
| K = | A4 = | A6 = | A8 = | A10 = | A12 = | A14 = | A16 = |
| 1.99852e+00 | 1.15677e−06 | −2.75064e−08 | −3.06848e−10 | 9.10515e−13 | 3.28486e−15 | 1.35261e−18 | 5.54400e−22 |
| A3 = | A5 = | A7 = | A9 = | A11 = | A13 = | A15 = | |
| 2.74335e−07 | 9.95673e−08 | 4.02226e−09 | 6.12079e−12 | −8.52506e−14 | −6.85632e−17 | −3.84859e−20 | |

Twenty-first surface

| | | | | | | | |
|---|---|---|---|---|---|---|---|
| K = | A4 = | A6 = | A8 = | A10 = | A12 = | A14 = | A16 = |
| 1.21093e+01 | 2.82183e−07 | −5.59441e−11 | −2.00796e−14 | 9.78964e−17 | −6.30815e−20 | 1.70834e−23 | −4.73901e−27 |
| A3 = | A5 = | A7 = | A9 = | A11 = | A13 = | A15 = | |
| −2.90901e−08 | 1.58196e−09 | 1.10620e−12 | −1.50730e−15 | 5.86871e−20 | 1.04584e−22 | 1.44467e−25 | |

Thirtieth surface

| | | | | | | | |
|---|---|---|---|---|---|---|---|
| K = | A4 = | A6 | A8 | A10 = | A12 = | A14 = | A16 = |
| −2.23400e+02 | 2.77687e−07 | 4.69555e−10 | 1.39733e−13 | −2.98156e−16 | 4.58582e−19 | −2.25443e−22 | 5.80568e−26 |
| A3 = | A5 = | A7 = | A9 = | A11 = | A13 = | A15 = | |
| 1.70768e−07 | −5.73181e−09 | −1.36230e−11 | 7.92918e−15 | −8.14405e−18 | 2.06016e−21 | −8.57551e−25 | |

Various data

| Zoom ratio | | | 120.00 | | |
|---|---|---|---|---|---|
| Focal length | 8.50 | 28.13 | 100.00 | 340.00 | 1020.00 |
| F-number | 1.75 | 1.75 | 1.75 | 1.75 | 5.25 |
| Angle of view | 32.91 | 11.06 | 3.15 | 0.93 | 0.31 |
| Image height | 5.50 | 5.50 | 5.50 | 5.50 | 5.50 |
| Total lens length | 678.72 | 678.72 | 678.72 | 678.72 | 678.72 |
| BF | 13.30 | 13.30 | 13.30 | 13.30 | 13.30 |
| d12 | 3.47 | 94.70 | 154.53 | 185.25 | 194.08 |
| d19 | 289.33 | 168.20 | 96.92 | 55.51 | 2.00 |
| d25 | 4.21 | 21.63 | 10.30 | 4.08 | 4.50 |
| d30 | 2.99 | 15.46 | 38.24 | 55.16 | 99.42 |

Zoom lens group data

| Group | Starting surface | Focal length |
|---|---|---|
| 1 | 1 | 251.50 |
| 2 | 13 | −24.07 |
| 3 | 20 | 134.62 |
| 4 | 26 | 112.37 |
| 5 | 31 | 41.15 |

TABLE 1
(B) Values of Inequalities

| | |
|---|---|
| (1) | 1.005 |
| (2) | −80 |

Reference values

| | |
|---|---|
| fu1 | −127.59 |
| fu2 | −126.98 |
| P | 0.0025 |
| SA | −0.20 |

### Second Numerical Example

### (A) Lens Configuration

### 2-3: When the Third Optical Unit 3 is Inserted (a High-Magnification State)

Unit: mm
Surface data

| Surface number | r | d | nd | νd |
|---|---|---|---|---|
| 1 | −2942.188 | 6.00 | 1.83481 | 42.7 |
| 2 | 335.459 | 1.80 | | |
| 3 | 335.066 | 23.71 | 1.43387 | 95.1 |
| 4 | −1057.929 | 0.20 | | |
| 5 | 525.299 | 14.68 | 1.43387 | 95.1 |
| 6 | −2449.905 | 25.25 | | |
| 7 | 377.042 | 20.53 | 1.43387 | 95.1 |
| 8 | −1365.497 | 0.25 | | |
| 9 | 306.954 | 16.16 | 1.43387 | 95.1 |
| 10 | 1716.232 | 1.50 | | |
| 11 | 188.244 | 16.19 | 1.43875 | 94.7 |
| 12 | 408.078 | (variable) | | |
| 13* | −532.824 | 2.20 | 2.00330 | 28.3 |
| 14 | 38.132 | 11.72 | | |
| 15 | −44.546 | 1.45 | 1.74320 | 49.3 |
| 16 | 72.565 | 9.77 | 1.89286 | 20.4 |
| 17 | −46.484 | 1.63 | | |
| 18 | −41.758 | 2.00 | 1.88300 | 40.8 |
| 19 | −152.608 | (variable) | | |
| 20 | 152.336 | 11.49 | 1.72916 | 54.7 |
| 21* | −265.715 | 6.62 | | |
| 22 | 139.888 | 13.50 | 1.43875 | 94.7 |
| 23 | −246.304 | 0.50 | | |
| 24 | 264.094 | 2.60 | 1.85478 | 24.8 |
| 25 | 97.106 | (variable) | | |
| 26 | 86.506 | 15.39 | 1.49700 | 81.5 |
| 27 | −236.969 | 0.50 | | |
| 28 | 415.877 | 2.50 | 1.80518 | 25.4 |
| 29 | 139.362 | 7.85 | 1.60311 | 60.6 |
| 30* | −764.201 | (variable) | | |
| 31(stop) | ∞ | 5.46 | | |
| 32 | −100.588 | 1.40 | 1.88300 | 40.8 |
| 33 | 50.285 | 1.36 | | |
| 34 | 40.817 | 3.60 | 1.92286 | 18.9 |
| 35 | 96.042 | 4.19 | | |
| 36 | −79.866 | 1.70 | 1.80400 | 46.5 |
| 37 | −114.439 | 5.00 | | |
| 38 | 81.692 | 4.99 | 1.43875 | 94.7 |
| 39 | −61.751 | 0.60 | | |
| 40 | 15.450 | 7.64 | 1.53172 | 48.8 |
| 41 | 65.646 | 0.90 | 2.00330 | 28.3 |
| 42 | 15.619 | 5.23 | | |
| 43 | 60.356 | 0.75 | 1.88300 | 40.8 |
| 44 | 12.180 | 5.75 | 1.74077 | 27.8 |
| 45 | 274.217 | 1.55 | | |
| 46 | −51.817 | 0.70 | 1.81600 | 46.6 |
| 47 | 97.938 | 7.66 | | |
| 48 | 95.109 | 5.83 | 1.51742 | 52.4 |
| 49 | −65.823 | 1.40 | | |
| 50 | −142.700 | 1.50 | 1.88300 | 40.8 |
| 51 | 37.951 | 7.64 | 1.48749 | 70.2 |
| 52 | −86.098 | 0.20 | | |
| 53 | 111.798 | 7.63 | 1.51742 | 52.4 |
| 54 | −35.378 | 1.50 | 1.88300 | 40.8 |
| 55 | −107.947 | 0.20 | | |
| 56 | 90.094 | 7.67 | 1.53996 | 59.5 |
| 57 | −53.741 | 10.00 | | |
| 58 | ∞ | 33.00 | 1.60859 | 46.4 |
| 59 | ∞ | 13.20 | 1.51633 | 64.2 |
| 60 | ∞ | 13.30 | | |
| Image plane | ∞ | | | |

Aspheric surface data
Thirteenth surface

| | | | | | | | |
|---|---|---|---|---|---|---|---|
| K = | A4 = | A6 = | A8 = | A10 = | A12 = | A14 = | A16 = |
| 1.99852e+00 | 1.15677e−06 | −2.75064e−08 | −3.06848e−10 | 9.10515e−13 | 3.28486e−15 | 1.35261e−18 | 5.54400e−22 |
| A3 = | A5 = | A7 = | A9 = | A11 = | A13 = | A15 = | |
| 2.74335e−07 | 9.95673e−08 | 4.02226e−09 | 6.12079e−12 | −8.52506e−14 | −6.85632e−17 | −3.84859e−20 | |

Twenty-first surface

| | | | | | | | |
|---|---|---|---|---|---|---|---|
| K = | A4 = | A6 = | A8 = | A10 = | A12 = | A14 = | A16 = |
| 1.21093e+01 | 2.82183e−07 | −5.59441e−11 | −2.00796e−14 | 9.78964e−17 | −6.30815e−20 | 1.70834e−23 | −4.73901e−27 |
| A3 = | A5 = | A7 = | A9 = | A11 = | A13 = | A15 = | |
| −12.90901e−08 | 1.58196e−09 | 1.10620e−12 | −1.50730e−15 | 5.86871e−20 | 1.04584e−22 | 1.44467e−25 | |

Thirtieth surface

| | | | | | | | |
|---|---|---|---|---|---|---|---|
| K = | A4 = | A6 | A8 = | A10 = | A12 = | A14 = | A16 = |
| −2.23400e+02 | 2.77687e−07 | 4.69555e−10 | 1.39733e−13 | −2.98156e−16 | 4.58582e−19 | −2.25443e−22 | 5.80568e−26 |
| A3 = | A5 = | A7 = | A9 = | A11 = | A13 = | A15 = | |
| 1.70768e−07 | −5.73181e−09 | −1.36230e−11 | 7.92918e−15 | −8.14405e−18 | 2.06016e−21 | −8.57551e−25 | |

Various data

| Zoom ratio | | | 120.00 | | |
|---|---|---|---|---|---|
| Focal length | 17.00 | 56.27 | 200.00 | 680.00 | 2039.99 |
| F-number | 3.50 | 3.50 | 3.50 | 3.50 | 10.50 |
| Angle of view | 17.93 | 5.58 | 1.58 | 0.46 | 0.15 |
| Image height | 5.50 | 5.50 | 5.50 | 5.50 | 5.50 |
| Total lens length | 677.55 | 677.55 | 677.55 | 677.55 | 677.55 |
| BF | 13.30 | 13.30 | 13.30 | 13.30 | 13.30 |
| d12 | 3.47 | 94.70 | 154.53 | 185.25 | 194.08 |
| d19 | 289.33 | 168.20 | 96.92 | 55.51 | 2.00 |
| d25 | 4.21 | 21.63 | 10.30 | 4.08 | 4.50 |
| d30 | 2.99 | 15.46 | 38.24 | 55.16 | 99.42 |

Zoom lens group data

| Group | Starting surface | Focal length |
|---|---|---|
| 1 | 1 | 251.50 |
| 2 | 13 | −24.07 |
| 3 | 20 | 134.62 |
| 4 | 26 | 112.37 |
| 5 | 31 | 774.73 |

### Third Numerical Example

### (A) Lens Configuration

### 3-4: When the Fourth Optical Unit 4 is Inserted (a Bokch State)

Unit: mm
Surface data

| Surface number | r | d | nd | νd |
|---|---|---|---|---|
| 1 | −2942.188 | 6.00 | 1.83481 | 42.7 |
| 2 | 335.459 | 1.80 | | |
| 3 | 335.066 | 23.71 | 1.43387 | 95.1 |
| 4 | −1057.929 | 0.20 | | |
| 5 | 525.299 | 14.68 | 1.43387 | 95.1 |
| 6 | −2449.905 | 25.25 | | |
| 7 | 377.042 | 20.53 | 1.43387 | 95.1 |
| 8 | −1365.497 | 0.25 | | |
| 9 | 306.954 | 16.16 | 1.43387 | 95.1 |
| 10 | 1716.232 | 1.50 | | |
| 11 | 188.244 | 16.19 | 1.43875 | 94.7 |
| 12 | 408.078 | (variable) | | |
| 13* | −532.824 | 2.20 | 2.00330 | 26.3 |
| 14 | 38.132 | 11.72 | | |
| 15 | −44.546 | 1.45 | 1.74320 | 49.3 |
| 16 | 72.565 | 9.77 | 1.89286 | 20.4 |
| 17 | −46.484 | 1.63 | | |
| 18 | −41.758 | 2.00 | 1.88300 | 40.8 |
| 19 | −152.608 | (variable) | | |
| 20 | 152.336 | 11.49 | 1.72916 | 54.7 |
| 21* | −265.715 | 6.62 | | |
| 22 | 139.888 | 13.50 | 1.43875 | 94.7 |
| 23 | −246.304 | 0.50 | | |
| 24 | 264.094 | 2.60 | 1.85478 | 24.8 |
| 25 | 97.106 | (variable) | | |
| 26 | 86.506 | 15.39 | 1.49700 | 81.5 |
| 27 | −236.969 | 0.50 | | |
| 28 | 415.877 | 2.50 | 1.80518 | 25.4 |
| 29 | 139.362 | 7.85 | 1.60311 | 60.6 |
| 30* | −764.201 | (variable) | | |
| 31(stop) | ∞ | 5.46 | | |
| 32 | −100.588 | 1.40 | 1.88300 | 40.8 |
| 33 | 50.285 | 1.36 | | |
| 34 | 40.817 | 3.60 | 1.92286 | 18.9 |
| 35 | 96.042 | 4.19 | | |
| 36 | −79.866 | 1.70 | 1.80400 | 46.5 |
| 37 | −114.439 | 7.69 | | |
| 38 | 502.742 | 1.50 | 1.80400 | 46.5 |
| 39 | 36.103 | 4.29 | 1.84666 | 23.9 |
| 40 | 140.382 | 6.83 | | |
| 41 | −42.145 | 1.50 | 1.89190 | 37.1 |
| 42 | 104.586 | 8.12 | 1.51633 | 64.1 |
| 43 | −29.853 | 12.96 | | |
| 44 | 95.109 | 5.83 | 1.51742 | 52.4 |
| 45 | −65.823 | 1.40 | | |
| 46 | −142.700 | 1.50 | 1.88300 | 40.8 |
| 47 | 37.951 | 7.64 | 1.48749 | 70.2 |
| 48 | −86.098 | 0.20 | | |
| 49 | 111.798 | 7.63 | 1.51742 | 52.4 |
| 50 | −35.378 | 1.50 | 1.88300 | 40.8 |
| 51 | −107.947 | 0.20 | | |
| 52 | 90.094 | 7.67 | 1.53996 | 59.5 |
| 53 | −53.741 | 10.00 | | |
| 54 | ∞ | 33.00 | 1.60859 | 46.4 |
| 55 | ∞ | 13.20 | 1.51633 | 64.2 |
| 56 | ∞ | 13.30 | | |
| Image plane | ∞ | | | |

Aspheric surface data
Thirteenth surface

| | | | | | | | |
|---|---|---|---|---|---|---|---|
| K = | A4 = | A6 = | A8 = | A10 = | A12 = | A14 = | A16 = |
| 1.99852e+00 | 1.15677e−06 | −2.75064e−08 | −3.06848e−10 | 9.10515e−13 | 3.28486e−15 | 1.35261e−18 | 5.54400e−22 |
| A3= | A5 = | A7= | A9 = | A11 = | A13 = | A15 = | |
| 2.74335e−07 | 9.95673e−08 | 4.02226e−09 | 6.12079e−12 | −8.52506e−14 | −6.85632e−17 | −3.84859e−20 | |

Twenty-first surface

| | | | | | | | |
|---|---|---|---|---|---|---|---|
| K = | A4 = | A6 = | A8 = | A10 = | A12 = | A14 = | A16 = |
| 1.21093e+01 | 2.82183e−07 | −5.59441e−11 | −2.00796e−14 | 9.78964e−17 | −6.30815e−20 | 1.70834e−23 | −4.73901e−27 |
| A3 = | A5 = | A7 = | A9 = | A11 = | A13 = | A15= | |
| −2.90901e−08 | 1.58196e−09 | 1.10620e−12 | −1.50730e−15 | 5.86871e−20 | 1.04584e−22 | 1.44467e−25 | |

Thirtieth surface

| | | | | | | | |
|---|---|---|---|---|---|---|---|
| K = | A4 = | A6 = | A8 = | A10 = | A12 = | A14 = | A16 = |
| −2.23400e+02 | 2.77687e−07 | 4.69555e−10 | 1.39733e−13 | −2.98156e−16 | 4.58582e−19 | −2.25443e−22 | 5.80568e−26 |
| A3 = | A5 = | A7 = | A9 = | A11 = | A13 = | A15 = | |
| 1.70768e−07 | −5.73181e−09 | −1.36230e−11 | 7.92918e−15 | −8.14405e−18 | 2.06016e−21 | −8.57551e−25 | |

Various data

| Zoom ratio | | | 120.00 | | |
|---|---|---|---|---|---|
| Focal length | 8.50 | 28.13 | 100.00 | 340.01 | 1020.02 |
| F-number | 1.75 | 1.75 | 1.75 | 1.75 | 5.25 |
| Angle of view | 32.90 | 11.06 | 3.15 | 0.93 | 0.31 |
| Image height | 5.50 | 5.50 | 5.50 | 5.50 | 5.50 |
| Total lens length | 679.67 | 679.67 | 679.67 | 679.67 | 679.67 |
| BF | 13.30 | 13.30 | 13.30 | 13.30 | 13.30 |
| d12 | 3.47 | 94.70 | 154.53 | 185.25 | 194.08 |
| d19 | 289.33 | 168.20 | 96.92 | 55.51 | 2.00 |
| d25 | 4.21 | 21.63 | 10.30 | 4.08 | 4.50 |
| d30 | 2.99 | 15.46 | 38.24 | 55.16 | 99.42 |
| d56 | 13.30 | 13.30 | 13.30 | 13.30 | 13.30 |

Zoom lens group data

| Group | Starting surface | Focal length |
|---|---|---|
| 1 | 1 | 251.50 |
| 2 | 13 | −24.07 |
| 3 | 20 | 134.62 |
| 4 | 26 | 112.37 |
| 5 | 31 | 40.37 |

TABLE 2
(B) Values of Inequalities

| | |
|---|---|
| (1) | 1.007 |
| (2) | −160 |

Reference values

| | |
|---|---|
| fu1 | −127.59 |
| fu2 | −126.73 |
| P | 0.0025 |
| SA | −0.40 |

### [Imaging Apparatus]

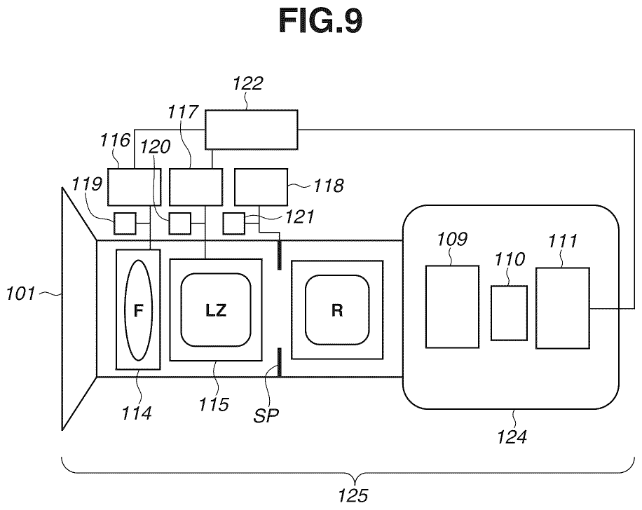

FIG. 9 illustrates a configuration of an imaging apparatus (a television camera system) in which the lens apparatus according to each of the exemplary embodiments is used as an imaging optical system. In FIG. 9, an imaging optical system 101 is an imaging optical system as the lens apparatus according to one of the first to third exemplary embodiments. A camera main body 124 is a main body of a camera. The imaging optical system 101 is detachably mounted on the camera main body 124. However, the imaging optical system 101 may be provided integrally with the camera main body 124.

The imaging optical system 101 includes a first lens group F, a zoom portion LZ, and a final lens group R for forming an image. The first lens group F includes a sub-lens group that moves in focusing.

The zoom portion LZ includes a plurality of lens groups that moves during zooming. The aperture stop SP is an aperture stop. Driving mechanisms 114 and 115, such as helicoids or cams, drive the lens groups consisting of the first lens group F and the zoom portion LZ in the optical axis direction. Motors 116 to 118 drive the driving mechanisms 114 and 115 and the aperture stop SP, respectively. Detectors 119 to 121, such as encoders, potentiometers, or photo sensors, are designed to detect positions of the lens groups consisting of the first lens group F and the zoom portion LZ in the optical axis direction, and an aperture diameter of the aperture stop SP, respectively.

The camera main body 124 includes a glass block 109 corresponding to an optical filter or a color separation optical system, and an image sensor 110, such as a charge-coupled device (CCD) sensor or a complementary metal-oxide semiconductor (CMOS) sensor, which photoelectrically converts subject images formed by the imaging optical system 101 (captures images of subjects through the imaging optical system 101).

Control units 111 and 122, such as central processing units (CPUs), control driving of the camera main body 124 and the imaging optical system 101.

In this manner, using the lens apparatus according to each of the exemplary embodiments as the imaging optical system makes it possible to implement the imaging apparatus capable of selectively performing imaging with different visual expressions.

While the exemplary embodiments of the specification have been described above, the specification is not limited to those exemplary embodiments and can be modified and changed in various manners without departing from the scope of the specification.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-157162, filed Sep. 11, 2024, which is hereby incorporated by reference herein in its entirety.

What is claimed is:

1. A lens apparatus comprising:
a plurality of lenses;
a first optical unit that includes a first part of the plurality of lenses;
a second optical unit that includes a second part of the plurality of lenses; and
a switching mechanism configured to switch between the first optical unit and the second optical unit, and
wherein a focal length of the first optical unit and a focal length of the second optical unit are equivalent to each other.

2. The lens apparatus according to claim 1, further comprising a third optical unit that includes a third part of the plurality of lenses, and that has a focal length different from the focal length of the first optical unit and the focal length of the second optical unit.

3. The lens apparatus according to claim 1, wherein the switching mechanism is configured to switch between the first optical unit and the second optical unit by rotation.

4. The lens apparatus according to claim 1, wherein a visual expression obtained by the lens apparatus with the first optical unit inserted in the lens apparatus and a visual expression obtained by the lens apparatus with the second optical unit inserted in the lens apparatus are different from each other.

5. The lens apparatus according to claim 1, wherein an imaging apparatus using the lens apparatus with the first optical unit inserted in the lens apparatus is configured to capture a sharp video image, and an imaging apparatus using the lens apparatus with the second optical unit inserted in the lens apparatus is configured to capture a video image with bokeh with respect to the sharp video image.

6. The lens apparatus according to claim 1, wherein, the following inequality is satisfied:
0.95<fu1/fu2<1.05,
where the focal length of the first optical unit is fu1 and the focal length of the second optical unit is fu2.

7. The lens apparatus according to claim 1, wherein, the following inequality is satisfied:
0.99<fu1/fu2<1.01,
where the focal length of the first optical unit is fu1 and the focal length of the second optical unit is fu2.

8. The lens apparatus according to claim 1, wherein, out of a plurality of lens groups included in the lens apparatus, the first optical unit and the second optical unit are disposed on an image side, and are a part of a lens group configured to not move during zooming.

9. The lens apparatus according to claim 1, wherein a passing light beam when the first optical unit or the second optical unit is inserted is afocal.

10. The lens apparatus according to claim 1, wherein a lens included in the first optical unit and a lens included in the second optical unit are different in at least one of a radius of curvature, a lens spacing, and a refractive index.

11. The lens apparatus according to claim 1, wherein a spherical aberration of an optical system when the first optical unit is inserted and a spherical aberration of the optical system when the second optical unit is inserted are different from each other.

12. The lens apparatus according to claim 1, wherein a spherical aberration of an optical system when the second optical unit is inserted is on an object side with respect to a light-receiving surface of a sensor with respect to a spherical aberration of the optical system when the first optical unit is inserted.

13. The lens apparatus according to claim 1, wherein, the following inequality is satisfied:
−170<SA/p<0,
where a pixel width of a sensor configured to capture an image formed by the lens apparatus is p and an amount of a spherical aberration is SA.

14. The lens apparatus according to claim 1, wherein, the following inequality is satisfied:
−85<SA/p<0,
where a pixel width of a sensor configured to capture an image formed by the lens apparatus is p and an amount of a spherical aberration is SA.

15. The lens apparatus according to claim 1, wherein a flange back position when the first optical unit is inserted and a flange back position when the second optical unit is inserted are different from each other.

16. The lens apparatus according to claim 15, further comprising a flange back adjustment mechanism configured to adjust the flange back position depending on an optical unit to be inserted.

17. The lens apparatus according to claim 15, wherein the flange back position when the second optical unit is inserted is on an object side with respect to a light-receiving surface of a sensor.

18. The lens apparatus according to claim 15, wherein the flange back position changes depending on a zoom state of the lens apparatus, a focus state of the lens apparatus, or an aperture stop state of the lens apparatus.

19. The lens apparatus according to claim 1, wherein a total number of lenses disposed in the first optical unit and a total number of lenses disposed in the second optical unit are equal to each other.

20. The lens apparatus according to claim 1, wherein the first optical unit and the second optical unit each includes a positive lens and a negative lens.

21. A lens apparatus comprising:
a plurality of lenses;
a first optical unit that includes a first part of the plurality of lenses;
a second optical unit that includes a second part of the plurality of lenses; and
a switching mechanism configured to switch between the first optical unit and the second optical unit, and
wherein a visual expression obtained by the lens apparatus with the first optical unit inserted in the lens apparatus and a visual expression obtained by the lens apparatus with the second optical unit inserted in the lens apparatus are different from each other.

22. An imaging apparatus comprising a lens apparatus and a sensor configured to capture an image formed by the lens apparatus,
wherein the lens apparatus comprising:
a plurality of lenses;
a first optical unit that includes a first part of the plurality of lenses;
a second optical unit that includes a second part of the plurality of lenses; and
a switching mechanism configured to switch between the first optical unit and the second optical unit, and
wherein a focal length of the first optical unit and a focal length of the second optical unit are equivalent to each other.

23. A lens apparatus comprising:
a plurality of lenses;
a first optical unit that includes a first part of the plurality of lenses;
a second optical unit that includes a second part of the plurality of lenses; and
a switching mechanism configured to switch between the first optical unit and the second optical unit, and
wherein the following inequality is satisfied:
0.95<fu1/fu2<1.05,
where the focal length of the first optical unit is fu1 and the focal length of the second optical unit is fu2.
